(19) United States
(12) Patent Application Publication
(10) Pub. No.: US 2005/0034411 A1
(43) Pub. Date: Feb. 17, 2005

(54) Weatherseal assembly, particularly for sealing a fixed window pane of a motor vehicle

(75) Inventor: Fritz Krause, Hergatz (DE)

Correspondence Address: Stephen B. Salai, Esq.;Harter, Secrest & Emery LLP, 1600 Bausch & Lomb Place, Rochester, NY, 14604-2711, US

(73) Assignee: Metzeler Automotive Profile Systems GmbH, Lindau/Bodensee (DE)

(21) Appl. No.: 10/897,863

(22) Filed: Jul. 23, 2004

(30) Foreign Application Priority Data
Jul. 25, 2003 (DE) 103 34 065.3

(51) Int. Cl. E05F 15/02

(52) U.S. Cl. 52/717.01

(57) ABSTRACT

A weatherseal assembly serving particularly for sealing a fixed window pane of a motor vehicle comprises a weatherseal made of an elastomeric material. In addition, the weatherseal assembly comprises a rigid component to which the weatherseal is securable. The weatherseal comprises an extruded sealing portion having at least one sealing lip and a mounting portion enclosing the window pane and connected to the sealing portion by bonding. The mounting portion is comprises a fastening means connected to the rigid component. To attain variable shaping of the sealing portion with reliable fastening the weatherseal is secured to the rigid component exclusively by the fastening means arranged on the mounting portion.

### CROSS-REFERENCE TO RELATED APPLICATIONS

This application claims priority of German Patent Application Number 103 34 065.3 filed Jul. 25, 2003, which is herewith incorporated by reference.

### BACKGROUND OF THE INVENTION

1. Field of the Invention

The invention relates to a weatherseal assembly serving particularly for sealing a fixed window pane of a motor vehicle. The weatherseal assembly comprises a weatherseal made of an elastomeric material. In addition the weatherseal assembly comprises a rigid component to which the weatherseal is securable. The weatherseal comprises an extruded sealing portion including at least one sealing lip and a mounting portion surrounding the window pane and connected to the sealing portion by bonding. The mounting portion has a fastening means connected to the rigid component.

2. Background Art

Motor vehicles often feature doors which comprise in addition to a movable, i.e. powered, window pane, a fixed window pane. The fixed window pane is often located in the region of the C-pillar of the motor vehicle and is separated from the movable window pane by a web. A frame holding the fixed window pane is usually made of an elastomer and mainly serves to sealingly secure the window pane to the door. One such profile frame is described in DE 196 32 843 C1.

Furthermore, DE 101 59 251 C1 discloses a weatherseal assembly comprising, in addition to a sash mounting a fixed window pane, a sealing portion serving to seal a motor vehicle door incorporating the fixed window pane from the body of the vehicle. The extruded sealing portion having at least one sealing lip comprises a fastening portion formed by a channel-type recess in thus making it possible to mount the sealing portion on a flange of the door. Effective non-positive connection between the sealing portion and the flange is ensured by a substantially U-shaped carrier which reinforces the sealing portion in the region of channel-type recess. The sash molded to the sealing portion comprises a hook-shaped fastening means positively connecting the sash to the door. The fastening means serves mainly to precisely locate the sash on the door. By contrast, reliably securing the sash and the sealing portion is achieved by mounting the sealing portion in the region of the channel-type recess on the door flange.

It is especially when the sealing portion is curved longitudinally and comprising, for example, an arcuate contour, as is often the case in the region of the C-pillar of a motor vehicle, that a U-shaped cross-section of the carrier reinforcing the sealing portion in the region of the fastening means has turned out to be unfavorable. For, the channel section mandatory for an effective non-positive connection dictates the radius of curvature and thus shaping the sealing portion.

### BRIEF SUMMARY OF THE INVENTION

The invention is based on the objective of sophisticating a weatherseal assembly serving particularly for sealing a fixed window pane of a motor vehicle such that with reliable fastening variable shaping of a sealing portion is now achievable.

To achieve this objective it is provided for in a weatherseal assembly having the features as cited above as it reads from claim 1 in accordance with the invention that the weatherseal is secured to the rigid component exclusively by the fastening means arranged on the mounting portion.

The weatherseal assembly in accordance with the invention makes use of having discovered that to reliably secure the weatherseal it is sufficient when the weatherseal is secured to the rigid component exclusively by the fastening means arranged on the mounting portion, there then being no need to provide the sealing portion with a fastening portion as described in DE 101 59 251 C1. A carrier with a U-shaped cross-section reinforcing the fastening portion of the known weatherseal assembly is now no longer needed, and thus the sealing portion of the weatherseal assembly in accordance with the invention can now be configured practically with no restrictions as regards the cross-section. The aspect in accordance with the invention now makes it possible to vary the shaping of the weatherseal cross-section in thus ensuring that the sealing portion features a radius of curvature adapted to the particular application. On top of this, the variable shaping capability inherent to the weatherseal assembly in accordance with the invention now makes it possible to vary the location of the neutral fibers of the sealing portion by reliable simple ways and means, for instance by heat treatment or drawing the sealing portion to attain a smooth finish in keeping with requirements.

Advantageous further embodiments of the weatherseal assembly in accordance with the invention read from the claims 2 to 12.

It has been discovered to be particularly of advantage to design the cross-section of the sealing portion more or less angled in comprising an inner leg on which the sealing lip is arranged and an outer leg connected to the mounting portion.

It is furthermore of advantage when the fastening means is a clip fastener, for a clip permits, on the one hand, no-problem assembly and disassembly and, on the other, adequate holding force in contributing towards a reliable and durable fastening of the weatherseal to the rigid component. One such suitable clip is described, for example, in the German patent application DE 102 52 597.

It is, on top of this, of advantage to configure the mounting portion with a groove for insertion of the window pane, in thus reliable ensuring that the window pane is secured to the mounting portion. Preferably, the mounting portion is strengthened by an insert. The insert preferably made of plastics or metal ensures adequate rigidity of the mounting portion in thus contributing towards reliable fastening of the weatherseal to the rigid component. In a preferred embodiment of the weatherseal assembly in accordance with the invention the insert has roughly the shape of an inverted L in clasping the groove mounting the window pane. It is this clasping of the groove that results in the window pane being securely clamped in place at the mounting portion in effectively contributing towards forced entry security.

The sealing portion is preferably free of any carrier, although when needed, it may be useful to strengthen the sealing portion by a substantially I- or L-section member. The member endows the sealing portion with a rigidity preventing the sealing portion from being shifted out of place when the sealing lip arranged on the sealing portion is compressed, for example, due to closing the door, squashing it against the body of the vehicle. When L-shaped, the carrier is embedded in both the inner leg and outer leg, whereas when I-shaped the carrier extends exclusively in the region of the inner leg.

Preferably the inner leg forms a contact face supporting the sealing portion at the rigid component. The contact face facilitates assembly of the weatherseal and contributes towards precisely locating the sealing portion on the rigid component.

To enhance the visual appeal, where necessary, the sealing portion is expediently provided in the region of the outer leg with a trimming part of colored plastics or a bright metal positively connected to the outer leg to ensure simple assembly.

It is furthermore expedient to finish the sealing lip with a friction-diminishing flaking or a coating for instance of a spray lubricant to prevent a friction noise nuisance. Flaking or coating the sealing lip in this way can be done directly following extrusion of the sealing portion so that after the mounting portion is joined to the sealing portion no subsequent finishing is needed. Where necessary, the sealing lip can be configured as a hollow chamber profile.

For uncomplicated, cost-effective fabrication the sealing portion is preferably extruded as an elastomer, for example a thermoplastic elastomer (TPE) or EPDM rubber, whereas the mounting portion is expediently joined to the sealing portion by injection molding.

Preferably the sealing portion is curved longitudinally and comprises, for example, an arcuate contour adapted to the C-pillar of a motor vehicle.

### BRIEF DESCRIPTION OF THE SEVERAL VIEWS OF THE DRAWING(S)

Further advantages of the weatherseal assembly in accordance with the invention will now be detained by way of example embodiments illustrated merely diagrammatically in the drawings in which:

FIG. 1 is a side view of a motor vehicle door;

FIG. 2 is a section taken along the line 11-11 in FIG. 1 showing a first embodiment of a sealing portion;

FIG. 3 is a section as shown in FIG. 2 but showing a second embodiment of the sealing portion;

FIG. 4 is a section as shown in FIG. 2 but showing a third embodiment of the sealing portion;

FIG. 5 is a section as shown in FIG. 2 but showing a fourth embodiment of the sealing portion;

FIG. 6 is a section as shown in FIG. 2 but showing a fifth embodiment of the sealing portion;

FIG. 7 is a section as shown in FIG. 2 but showing a sixth embodiment of the sealing portion, and

FIG. 8 is a section as shown in FIG. 2 but showing a seventh embodiment of the sealing portion;

### DETAILED DESCRIPTION OF THE INVENTION

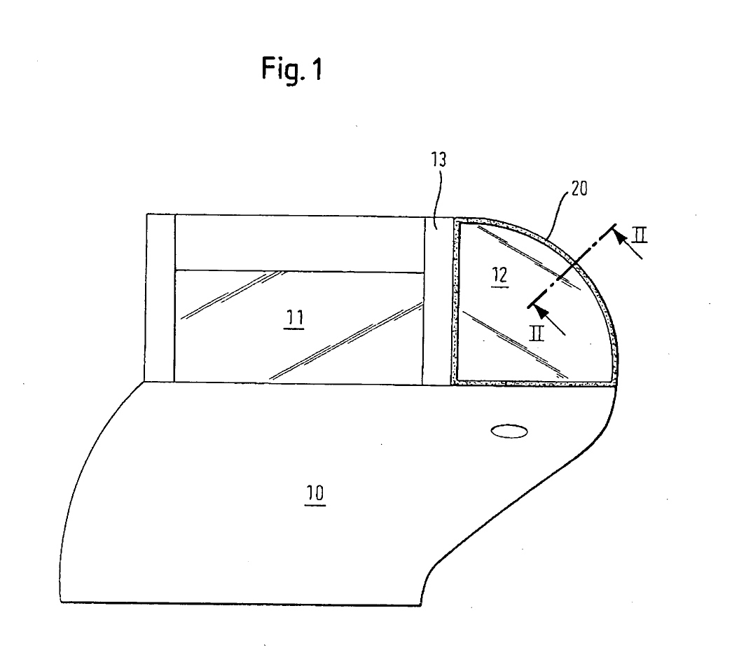

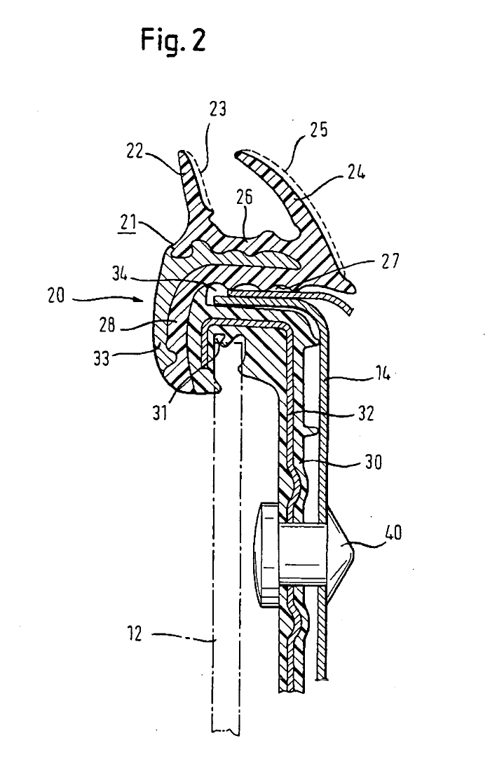

Referring now to FIG. 1 there is illustrated a motor vehicle door 10 comprising a movable window pane 11 for powered vertical motion in a cavity of the door 10. In addition the door 10 comprises a fixed window pane 12 separated from the movable window pane 11 by a web 13 and is enclosed by a weatherseal 20. Referring now to FIG. 2 there is illustrated particularly evidently how the weatherseal 20 is composed of a sealing portion 21 comprising sealing lips 22, 24 and a mounting portion 30 enclosing the window pane 12. The mounting portion 30 comprises a groove 31 into which the window pane 12 is inserted. In addition, the mounting portion 30 is strengthened by an insert 32 made of plastics or metal having roughly the shape of an inverted L and clasping the groove 31. Arranged at a portion of the insert 32 extending parallel to the window pane is a clip fastener 40. This clip fastener 40 connects the mounting portion 30 to a frame 14 of the door 10.

The sealing portion 21 is extruded in an elastomer, for example EPDM, and configured with a substantially angled cross-section. Arranged at an inner leg 26 are the sealing lips 22, 24 finished with a flaking 23, 25. Secured to the outer leg 28 is the mounting portion 30. The mounting portion 30 made of TPE, for example, is joined to the outer leg 28 by injection molding such that a space 34 remains between the inner leg 26 and the mounting portion 30. Engaging the space 34 is an angled portion of the frame 14. A contact face 27 forming the inner leg 26 supports the sealing portion 21 at the angled portion of the frame 14.

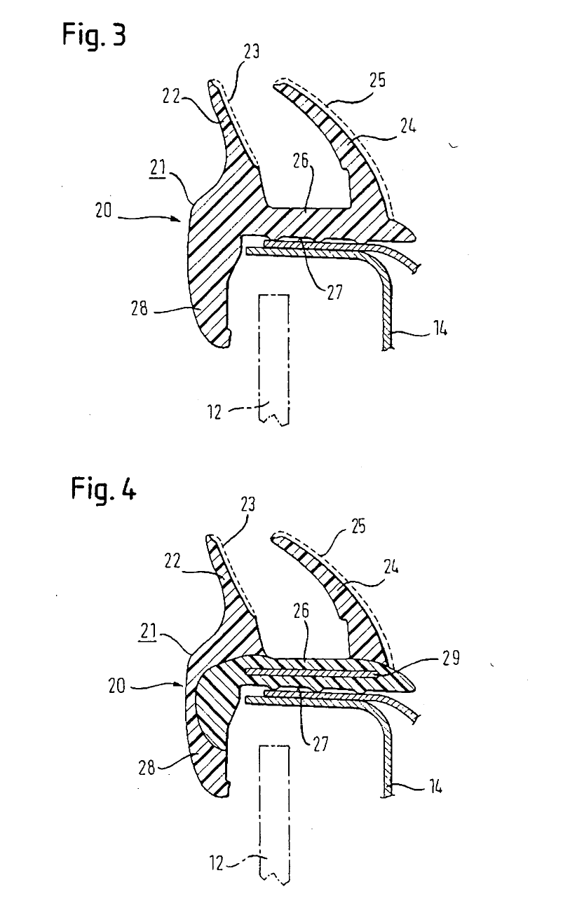

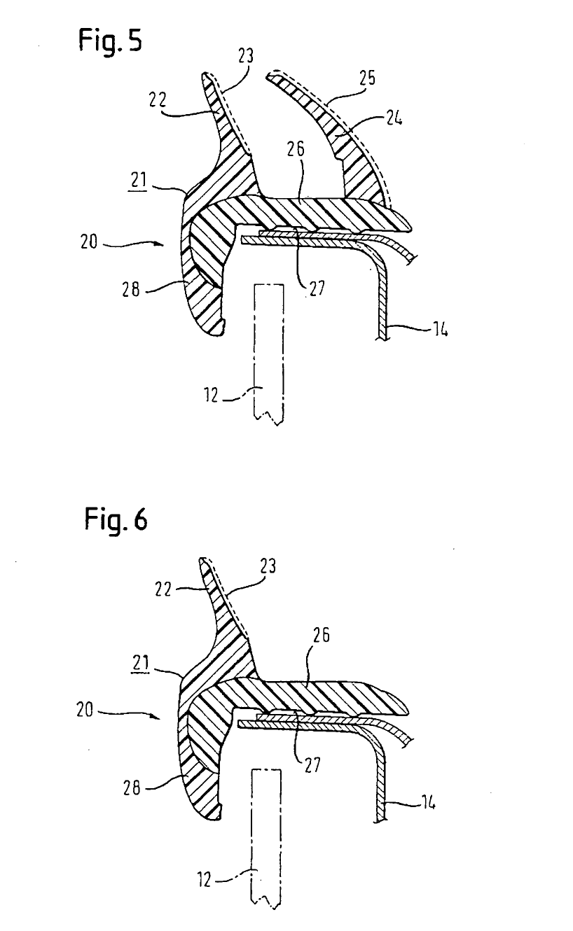

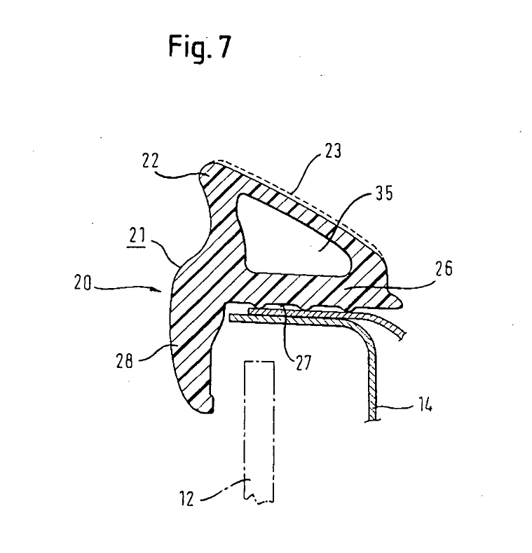

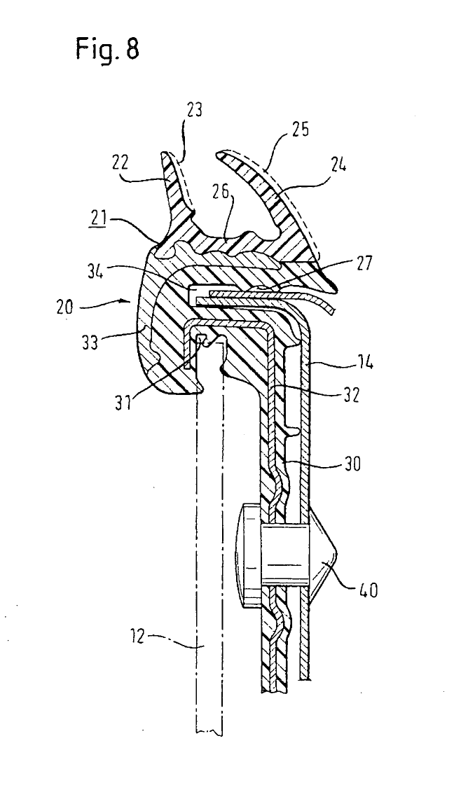

Referring now to FIGS. 2 and 8 there is illustrated an embodiment of the sealing portion 21 comprising a trimming part 33 arranged in the region of the outer leg 28. By contrast, the embodiments of the sealing portion 21 as shown in FIGS. 3 to 7 have no trim. The sealing portion 21 as shown in FIGS. 3, 7 and 8 is made of a homogenous material, whereas the embodiments of the sealing portion 21 as shown in FIGS. 4 to 6 are made of a heterogeneous material and fabricated, for example, by coextrusion. Thus, for example, the inner leg 26 may be made of a material exhibiting a reliable elevated hardness to ensure adequate dimensional stability of the sealing portion 21. For this purpose, the inner leg 26 may be reinforced in addition by an I-shaped carrier 29, as evident from FIG. 4. The sealing portion 21 must not necessarily have two sealing lips 22, 24. Instead, where necessary, it may be sufficient when only one sealing lip 22 is provided, as evident from FIG. 6. In addition, the sealing lip 22 may also be configured as a hollow chamber profile, depending on the particular application, in including a hollow chamber 35 ensuring a reliable seal.

Referring now to FIG. 8 there is illustrated a weatherseal 20 comprising a sealing portion 21 with a cross-section configured substantially flat and accordingly having only one inner leg 26. The sealing portion 21 comprising the two sealing lips 22, 24 is joined at the side of the inner leg 26 facing away from the sealing lips 22, 24 to the mounting portion 30. The mounting portion 30 produced by injection molding extends into the portion which in the embodiments as shown in FIGS. 2 to 7 is formed by the outer leg 28. A trimming part 33 is then secured directly to the mounting portion 30.

The weatherseal assembly as described above for sealing the fixed window pane 12 of the door 10 is characterized by reliable fastening of the weatherseal 20 to the frame 14 by virtue of the fact that the clip fastener 40 secures both the mounting portion 30 and the sealing portion 21, which is connected by bonding to the mounting portion 30, to the frame 14. As compared to this, the contact face 27 of the inner leg 26 adjoining the angled section of the frame 14 merely contributes to align the sealing portion 21 relative to the frame 14. Accordingly, the clip fastener 40 is exclusively responsible for securing the weatherseal 20 to the frame 14. Unlike the weatherseal assembly known from DE 101 59 251 C1 there is now no need for a carrier with a U-shaped cross-section to secure the sealing portion 21 to the frame 14. Instead, the sealing portion 21 can now be configured without any reinforcing whatsoever as evident from FIGS. 2, 3 and 5 to 8. However, should reinforcing prove necessary to achieve adequate dimensional stability of the sealing portion 21, it is sufficient when reinforcing is formed by an I-shaped carrier extending exclusively in the region of the inner leg 26, as is evident from FIG. 4.

Now, because of a U-shaped carrier being eliminated, variable shaping of the sealing portion 21 is assured as is particularly evident when the sealing portion 21 is curved longitudinally, as evident from FIG. 1. For, in this case, the location of the neutral fibers of the sealing portion 21 can now be adapted to the arcuate contour of the sealing portion 21 with no complication, for example, by heat treatment or drawing the sealing portion 21. Now, in addition to a configuration in keeping with the load requirements this thus achieves, last but not least, a smooth contour of the sealing portion 21 with enhanced visual appeal.

1. A weatherseal assembly for sealing a fixed window pane of a motor vehicle, comprising a weatherseal made of an elastomeric material and a rigid component to which said weatherseal is securable, said weatherseal comprising an extruded sealing portion having at least one sealing lip and a mounting portion enclosing said window pane and connected to said sealing portion by bonding, said mounting portion having a fastening means connected to said rigid component, said weatherseal being secured to said rigid component mainly by said fastening means arranged on said mounting portion, and said mounting portion being reinforced by an insert.

2. The weatherseal assembly as set forth in claim 1, wherein the cross-section of said sealing portion is substantially angled and comprises an inner leg on which said sealing lip is arranged and an outer leg connected to said mounting portion.

3. The weatherseal assembly as set forth in claim 1, wherein said fastening means is a clip fastener.

4. The weatherseal assembly as set forth in claim 1, wherein said mounting portion includes a groove for insertion of said window pane.

5. The weatherseal assembly as set forth in claim 4, wherein said insert has a substantially Γ-shaped cross-section and wherein said insert clasps said groove.

6. The weatherseal assembly as set forth in claim 1, wherein said sealing portion is reinforced by a carrier having a preferably I- or L-shaped cross-section.

7. The weatherseal assembly as set forth in claim 2, wherein said inner leg defines a contact face supporting said sealing portion at said rigid component.

8. The weatherseal assembly as set forth in claim 2, wherein said sealing portion comprises a trimming part in the region of said outer leg.

9. The weatherseal assembly as set forth in claim 1, wherein said sealing lip is finished with a friction-diminishing flaking or coating.

10. The weatherseal assembly as set forth in claim 1, wherein said sealing portion is extruded as an elastomer, preferably a thermoplastic elastomer (TPE) or EPDM rubber.

11. The weatherseal assembly as set forth in claim 10, wherein said mounting portion is joined to said sealing portion by injection molding.

12. The weatherseal assembly as set forth in claim 1, wherein said sealing portion is curved longitudinally.
